(19) United States
(12) Patent Application Publication
(10) Pub. No.: US 2019/0084676 A1
(43) Pub. Date: Mar. 21, 2019

(54) SYSTEMS AND METHODS FOR PROVIDING VISUAL IDENTIFICATION OF A WIND TURBINE FLOW FIELD

(71) Applicant: General Electric Company, Schenectady, NY (US)

(72) Inventors: Benjamin Patrick Hallissy, Greenville, SC (US); James Robert Tobin, Simpsonville, SC (US); Stefan Herr, Greenville, SC (US); Megan Wilson, Greenville, SC (US); Andreas Herrig, Garching bei Munchen (DE); Matthew Rece, Fort Lauderdale, FL (US)

(21) Appl. No.: 15/707,010

(22) Filed: Sep. 18, 2017

(51) Int. Cl. B64D 1/02; A63J 5/02; G05B 13/04; F03D 17/00; F03D 7/02; G01M 15/14

(52) U.S. Cl. CPC B64D 1/02; A63J 5/025; G05B 13/041; F03D 17/00; F03D 7/0204; F05B 2260/84; F05B 2260/83; F05B 2260/74; F05B 2260/80; F05B 2260/821; G01M 15/14

(57) ABSTRACT

A method for providing visual identification of a flow field across one or more wind turbines includes releasing at least one tracer material from at least one predetermined location of the wind turbine. The method also includes synchronizing the releasing of the tracer material with at least one of one or more operating parameters or one or more wind parameters of the wind turbine. Further, the method includes monitoring, via one or more sensors, a resultant flow pattern of the tracer material from one or more uptower locations.

### FIELD

The present subject matter relates generally to wind turbines and, more particularly, to systems and methods for providing visual identification of wind turbine airflow.

### BACKGROUND

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known airfoil principles. For example, rotor blades typically have the cross-sectional profile of an airfoil such that, during operation, air flows over the blade producing a pressure difference between the sides. Consequently, a lift force, which is directed from a pressure side towards a suction side, acts on the blade. The lift force generates torque on the main rotor shaft, which is geared to a generator for producing electricity.

Visualizing aerodynamic flow fields is a challenging task. In general, flow visualization has been employed by scientists and engineers for many years. More specifically, some basic components of experimental flow visualization include (1) an element or tracer that tracks the flow (e.g. certain types of particles or a property of the fluid such as density), (2) an observer (e.g. the human eye or a digital capture device that can see the tracer motion or lack thereof), and (3) a system that interprets the observed motion of the tracer, or synchronizes said motion with some other quantity (time, flow rate, etc.). Such steps generally result in an improved understanding of the flow field of interest.

Flow visualization typically occurs under controlled conditions in a wind or water tunnel. In other situations, flow visualization is attempted (or occurs naturally) in less-predictable field conditions. Flow fields can be visualized in free space or near solid surfaces. Examples of common techniques include surface methods like oil flow visualization or pressure sensitive paint (steady or unsteady), particle tracer methods (e.g. smoke, microspheres, or bubbles of some sort visualized with high-speed cameras, photogrammetry, particle image velocimetry or laser Doppler velocimetry), and/or optical methods that rely on variations in refractive index (e.g. Schlieren, shadowgraph, and interferometry).

Wind tunnel flow visualization, though routinely performed, is limited to a narrow range of freestream turbulence levels and length scales. Further, if modeling an entire wind turbine in the wind tunnel, the Reynolds number and/or reduced frequencies associated with the flow are likely different from field conditions. In the field, though the physics are realistic, the freestream conditions become uncontrolled and more uncertain. In addition, the physical size of modern utility scale wind turbines and the environmental conditions found in the field (e.g. moisture, vibration, temperature extremes, etc.) limits the applicability of many laboratory-friendly visualization techniques.

More specifically, challenges for full-scale wind turbine flow visualization include, at least, how to consistently release tracer particles at one point in a turbulent wind field at altitudes above ground level (e.g. at heights on the order of 200 meters), and how to place the observer in a position to steadily record and interpret the flow field that is revealed.

Accordingly, the present disclosure is directed to systems and methods for providing visual identification of wind turbine airflow that addresses the aforementioned issues.

### BRIEF DESCRIPTION

Aspects and advantages of the invention will be set forth in part in the following description, or may be obvious from the description, or may be learned through practice of the invention.

In one aspect, the present disclosure is directed to a method for providing visual identification of a flow field across one or more wind turbines. The method includes releasing at least one tracer material from at least one predetermined location near the one or more wind turbines. The method also includes synchronizing the releasing of the tracer material with at least one of one or more operating parameters or one or more wind parameters of the one or more wind turbines. Further, the method includes monitoring, via one or more sensors, a resultant flow pattern of the tracer material.

In one embodiment, the method may include releasing the tracer material(s) in a continuous stream or one or more bursts. In another embodiment, the method may include releasing a plurality of tracer materials having a plurality of different colors. In further embodiments, the method may include releasing the tracer material(s) in a vertical line, a horizontal line, a grid pattern, or combinations thereof, or any other suitable pattern.

In additional embodiments, the step of releasing the tracer material(s) from the predetermined location(s) may include releasing the tracer material(s) from a first unmanned aerial vehicle (UAV) flying uptower, an uptower location on the one or more wind turbines, and/or one or more aircrafts. More specifically, in one embodiment, the method may include releasing the tracer material(s) from a tracer generator secured to a tether extending downward from the first UAV.

In several embodiments, the method may include receiving, via the first UAV, a remote triggering signal from an operator and releasing the tracer material in response to receiving the triggering signal.

In certain embodiments, the step of monitoring, via the one or more sensors, the resultant flow pattern of the tracer material may include providing a second UAV at an upstream location from the first UAV and monitoring, via at least one second sensor mounted to the second UAV, the resultant flow pattern of the tracer material.

In particular embodiments, the method may include directing the second sensor mounted to the second UAV downward toward a nacelle of one of the one or more wind turbines and adjusting, via the first UAV, at least one of a vertical position or a lateral position of the tracer material to target a desired area near the one or more wind turbines.

In yet another embodiment, the step of monitoring, via the one or more sensors, the resultant flow pattern of the tracer material may further include monitoring, via at least one of an additional UAV separate from the first and second UAVs or an additional sensor mounted to or near the one or more wind turbines, the resultant flow pattern of the tracer material.

In further embodiments, the method may include monitoring the resultant flow pattern of the tracer material from one or more uptower locations and/or one or more ground locations. In such embodiments, the uptower location(s) may include an upstream position relative to a rotor of the one or more wind turbines, a downstream position relative to the rotor, above a nacelle of the one or more wind turbines, below the nacelle, from a side of the nacelle, below the predetermined location, or another other suitable position uptower of the one or more wind turbines. In additional embodiments, the operating parameter(s) may include a turbine speed, a yaw angle, a pitch angle, a power output, a torque output, or similar. Further, the wind parameter(s) may include wind speed, wind turbulence, wind gust, wind shear, wind direction, or similar.

In specific embodiments, the tracer material may include solid particulates, liquid particulates, or combinations thereof.

In another aspect, the present disclosure is directed to a system for providing visual identification of a flow field across one or more wind turbines. The system includes at least one tracer material, a first aircraft at a first uptower location for releasing the at least one tracer material from at least one predetermined location of the one or more wind turbines, one or more sensors for monitoring a resultant flow pattern of the tracer material from one or more uptower locations, and a controller communicatively coupled to the one or more sensors. Further, the controller is configured for receiving data relating to the monitored resultant flow pattern and implementing a control action based on the resulting flow pattern.

In one embodiment, the first aircraft may include an unmanned aerial vehicle (UAV) or drone, an airplane, a helicopter, a rocket, a tethered balloon, a kite, or similar. In another embodiment, the system may also include a tracer generator and at least one tether secured to and extending downward from the first aircraft. In such embodiments, the tracer generator is configured for releasing the at least one tracer material.

In additional embodiments, the first aircraft may include a stabilizing device for stabilizing the predetermined location. For example, in such embodiments, the stabilizing device may include a parachute, a vertical stabilizer, a horizontal stabilizer, a kite tail, a wind screen, a mechanical tether connected to the ground, a gyroscopic mechanism, or any other suitable device for stabilizing the predetermined location (i.e. the release point of the tracer material).

In further embodiments, the system may also include a second aircraft adapted with one of the one or more sensors for further monitoring the resultant flow pattern of the tracer material.

In additional embodiments, the system may include an additional aircraft separate from the first and second aircrafts and/or an additional sensor mounted to or near the wind turbine for further monitoring the resultant flow pattern. It should be further understood that the system may further include any of the additional features described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates a perspective, interior view of one embodiment of a nacelle of a wind turbine according to the present disclosure; and,

FIG. 3 illustrates a side view of one embodiment of a system for providing visual identification of a flow field of a wind turbine according to the present disclosure;

FIG. 4 illustrates a top view of one embodiment of a system for providing visual identification of a flow field of a wind turbine according to the present disclosure;

FIG. 5 illustrates a perspective view of one embodiment of a tracer generator of a system for providing visual identification of a flow field of a wind turbine according to the present disclosure;

FIG. 6 illustrates a perspective view of one embodiment of a system for providing visual identification of a flow field of a wind turbine according to the present disclosure, particularly illustrating a tracer material being released from the nacelle;

FIG. 7 illustrates a perspective view of another embodiment of a system for providing visual identification of a flow field of a wind turbine according to the present disclosure, particularly illustrating two tracer materials being released from a parked rotor;

FIG. 8 illustrates a perspective view of yet another embodiment of a system for providing visual identification of a flow field of a wind turbine according to the present disclosure, particularly illustrating four different tracer materials being released from the nacelle;

FIG. 9 illustrates a perspective view of one embodiment of a system for providing visual identification of a flow field of a wind turbine according to the present disclosure, particularly illustrating a tracer material being released from a parked rotor;

FIG. 10 illustrates a perspective view of one embodiment of a system for providing visual identification of a flow field of a wind turbine according to the present disclosure, particularly illustrating three tracer materials being released from a first drone upstream of the wind turbine;

FIG. 11 illustrates a perspective view of one embodiment of a system for providing visual identification of a flow field of a wind turbine according to the present disclosure, particularly illustrating four tracer materials being released from a first drone upstream of the wind turbine;

FIG. 12 illustrates a perspective view of one embodiment of a system for providing visual identification of a flow field of a wind turbine according to the present disclosure, particularly illustrating an additional sensor located on the ground near the wind turbine;

FIG. 13 illustrates a perspective view of one embodiment of a system for providing visual identification of a flow field across a plurality of wind turbines in a wind farm according to the present disclosure, particularly illustrating a plurality of rockets releasing tracer material near the wind turbine;

FIG. 14 illustrates a block diagram of one embodiment of a controller of a wind turbine according to the present disclosure; and

FIG. 15 illustrates a flow diagram of one embodiment of a method for providing visual identification of a flow field of a wind turbine according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present disclosure is directed to a system and method for providing visual identification of the flow field in proximity to a wind turbine using a combination of remotely-triggered pyrotechnic or aviation smoke tracers and one or more aircrafts, such as semi-autonomous unmanned aerial vehicles (UAVs). More specifically, in one embodiment, the method releasing the smoke from a consistent, repeatable point in space, regardless of the height above ground level, monitoring the resultant flow patterns from a variety of positions (e.g. downstream, above, to the side, and below the release point, and synchronizing the release of the smoke with the wind turbine operating parameters and/or the met mast data recorder or other atmospheric and/or wind data (e.g. from SODAR or LIDAR sensors).

Thus, the present disclosure provides many advantages not present in the prior art. For example, the flow field of the wind turbine can be easily visualized without the use of large, expensive cranes, man-baskets or cherry pickers. In addition, the GPS-based position-hold mode of the UAVs (when combined with image-stabilized, gimbaled cameras) provides a steady platform for data gathering. Moreover, the UAVs and tracer generators of the present disclosure are versatile and can be easily repurposed for different types of tracer release.

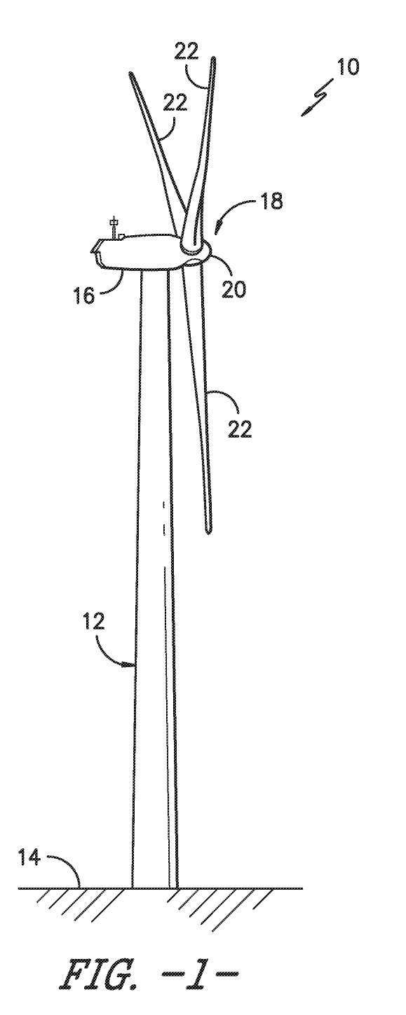

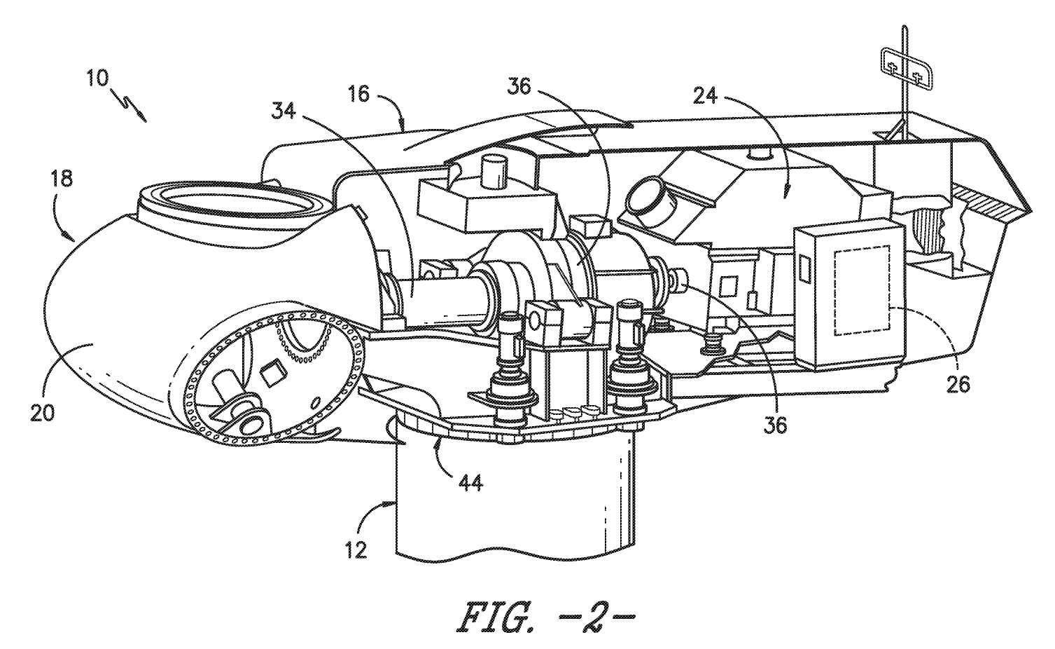

Referring now to the drawings, FIG. 1 illustrates perspective view of one embodiment of a wind turbine 10 according to the present disclosure. As shown, the wind turbine 10 includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator 24 (FIG. 2) positioned within the nacelle 16 to permit electrical energy to be produced.

As shown, the wind turbine 10 may also include a turbine control system or turbine controller 26 centralized within the nacelle 16. However, it should be appreciated that the turbine controller 26 may be disposed at any location on or in the wind turbine 10, at any location on the support surface 14 or generally at any other location. The turbine controller 26 may generally comprise as any suitable processing unit configured to perform the functions described herein. Thus, in several embodiments, the turbine controller 26 may include suitable computer-readable instructions that, when implemented, configure the controller 26 perform various different actions, such as transmitting and executing wind turbine control signals, receiving and analyzing sensor signals, and/or generating message signals. By transmitting and executing wind turbine control signals, the turbine controller 26 may generally be configured to control the various operating modes (e.g., start-up or shut-down sequences) and/or components of the wind turbine 10.

Referring now to FIG. 2, a simplified, internal view of one embodiment of the nacelle 16 of the wind turbine 10 is illustrated. As shown, the generator 24 may be disposed within the nacelle 16. In general, the generator 24 may be coupled to the rotor 18 of the wind turbine 10 for generating electrical power from the rotational energy generated by the rotor 18. For example, the rotor 18 may include a rotor shaft 34 coupled to the hub 20 for rotation therewith. The generator 24 may then be coupled to the rotor shaft 34 such that rotation of the rotor shaft 34 drives the generator 24. For instance, in the illustrated embodiment, the generator 24 includes a generator shaft 36 rotatably coupled to the rotor shaft 34 through a gearbox 38. However, in other embodiments, it should be appreciated that the generator shaft 36 may be rotatably coupled directly to the rotor shaft 34. Alternatively, the generator 24 may be directly rotatably coupled to the rotor shaft 34 (often referred to as a “direct-drive wind turbine”).

During operation of the wind turbine 10, it may be beneficial to monitor various operating and/or wind conditions of or near the wind turbine 10. For example, such parameters may be monitored and then utilized by the turbine controller 26 to implement a corrective action. Such corrective action may in turn reduce loads acting on the wind turbine 10, thereby increasing the operating life thereof. In one embodiment, it may be beneficial to visually detect a flow field of the wind turbine 10 as the flow field is generally indicative of wind turbulence, wind speed, and/or other wind parameters affecting operation and/or components of the wind turbine 10.

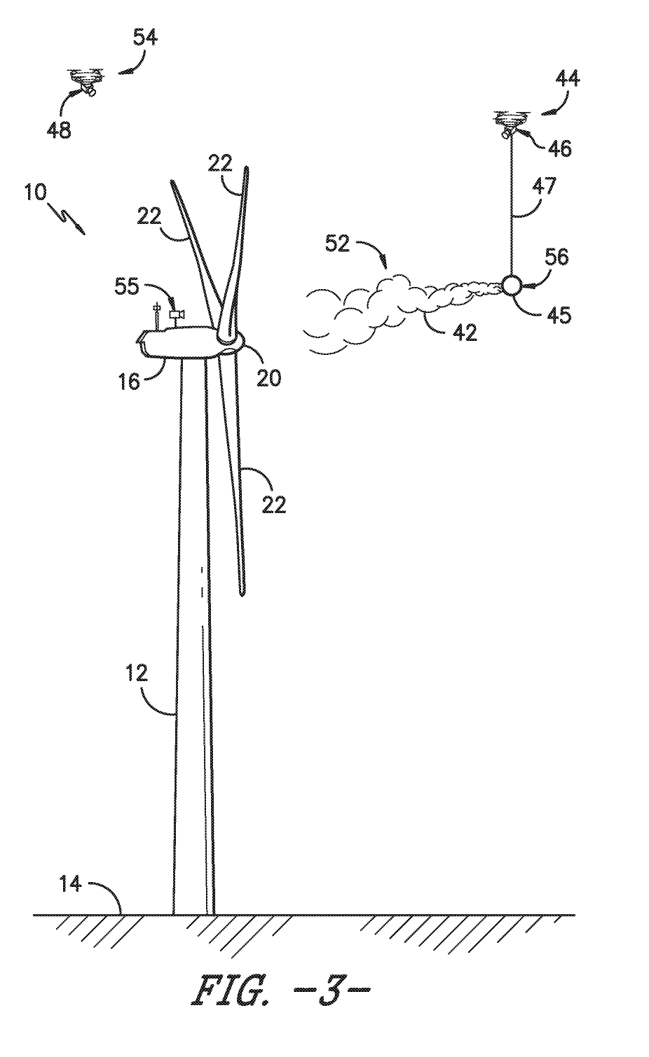

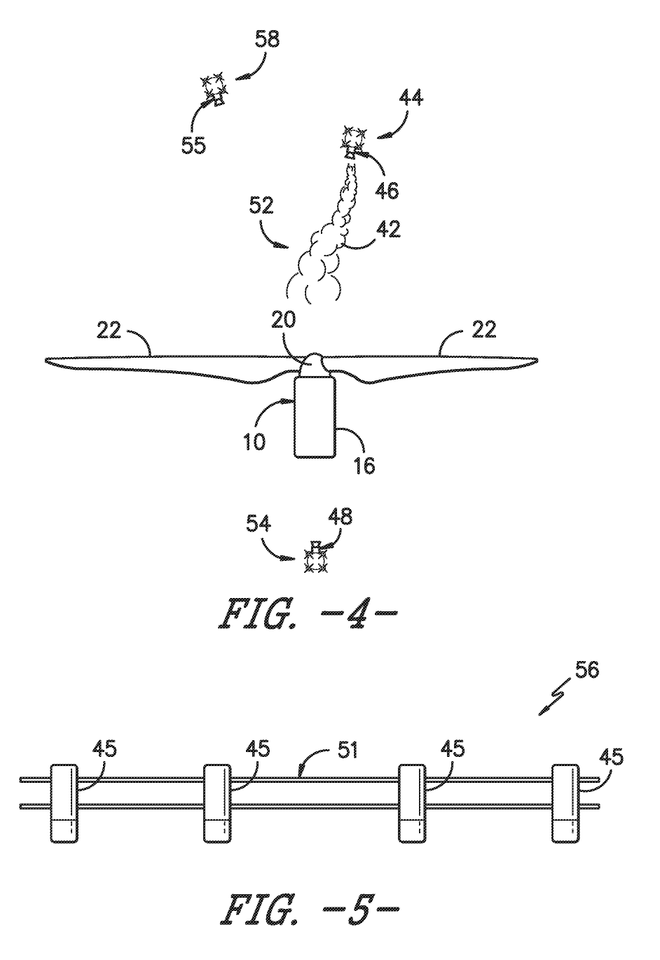

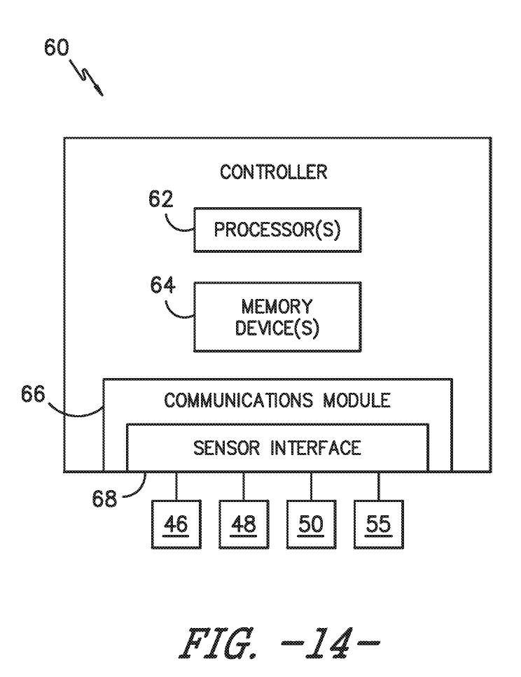

Accordingly, FIGS. 3 and 4 illustrate schematic diagrams of various embodiments of a system 40 for providing visual identification of a flow field of the wind turbine 10 according to the present disclosure is illustrated. More specifically, FIG. 3 illustrates a side view of one embodiment of the system 40 according to the present disclosure, whereas FIG. 4 illustrates a top view of another embodiment of the system 40 according to the present disclosure. As shown in FIGS. 3 and 4, the system 40 includes at least one tracer material 42 and a first aircraft 44 for releasing the tracer material(s) 42 from at least one predetermined location of the wind turbine 10. In certain embodiments, the first aircraft 44 may correspond to an unmanned aerial vehicle (UAV), an airplane, a helicopter, one or more rockets 70 (FIG. 13), a tethered balloon, or a kite. For example, as shown in FIGS. 3 and 4, the first aircraft 44 corresponds to a UAV or drone. In certain embodiments, the system 40 may include a plurality of aircrafts, though not required. Thus, in one embodiment, the first aircraft 44 may be used alone and may include at least one sensor 46 (such as a camera sensor) to perform the dual functions of both tracer release and visualization.

In a preferred embodiment, as shown in FIGS. 3-5, the first aircraft 44 may be a large drone with excess lift capacity capable of carrying a tracer generator 45 for releasing the tracer material(s) 42. More specifically, as shown, the tracer generator 45 may be secured to a tether 47 extending downward from the UAV 44. Thus, as shown, the first drone 44 is configured to lift the tracer generator 45 uptower and upstream of the rotor 18 so as to maintain the tracer generator 45 in a predetermined position during operation. In such embodiments, the tracer generator 45 is configured for releasing the tracer material(s) 42.

The tracer material(s) 42 described herein may include any suitable material having, for example, solid particulates, liquid particulates, or combinations thereof. More specifically, example tracer materials 42 may include, but are not limited to pyrotechnic smoke, aviation smoke, natural particles (e.g. fog, snow, sand, dust, etc.), foam or aerogel particles, as well as other extremely low-density materials such that the particle follows streamlines, retroreflective particles for which photogrammetry can be used for motion capture, steam or smoke utilizing any source of heat energy, chemiluminescent or fluorescent particles, soap bubbles or soap film, neutrally-buoyant weighted helium balloons or other neutrally buoyant objects, a plurality of micro-drones relaying position versus time telemetry, and/or any other suitable materials or particles.

In addition, the tracer material(s) 42 may also be suspended or released in several different ways. For example, in one embodiment, the tracer material(s) 42 may be release in a continuous stream or one or more bursts. Further, the tracer generator 45 may be suspended upstream, downstream, or in the rotor plane. Alternatively, the tracer generator 45 may be suspended from kites, balloons, or aerostats. Further, the tracer generator 45 may be suspended from strings or cables from the nacelle 16, such as between various objects/structures to create an array. As such, the tracer material(s) 42 can be released from the tracer generator at any suitable location, including for example, at the met mast, from the rotor blades 22, tower 12, nacelle 16, or a manned helicopter. Alternatively, as shown in FIG. 13, the tracer material(s) 42 may also be released from one or more rocket 70 (or multiple simultaneously or separately launched rockets 70) during ascent (or descent).

It should be understood that the tether(s) 47 described herein may have any suitable length depending on a desired release height of the tracer material(s) 42. For example, in one embodiment, the tether 47 may be long enough to remove the tracer source from the influence of drone prop wash. More specifically, in particular embodiments, the tether(s) 47 may be about ten (10) meters, but can vary with the drone type and payload weight. As such, in further embodiments, the tether(s) 47 may have a length that is less than 10 meters or greater than 10 meters.

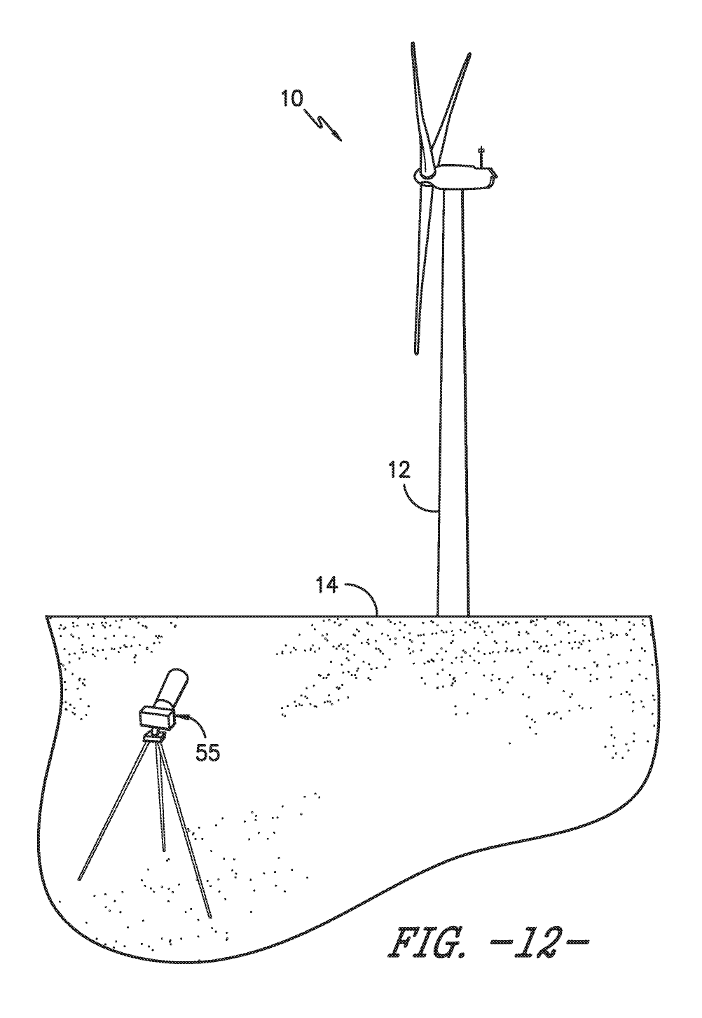

Referring to FIGS. 3-12, various embodiments of the system 40 according to the present disclosure are illustrated, particularly illustrating different methods for releasing the tracer material(s) 42. Further, as shown, the tracer material(s) 42 may include multiple colors of smoke that are released in variety of patterns. More specifically, as shown in FIGS. 3, 4, 10, and 11, the tracer material(s) 42 are released using the first UAV 44. For example, as shown in FIG. 10, the first UAV 44 flies upstream of the rotor 20, lifts the tracer generator 45 to a predetermined location, and then releases three different tracer materials 42 having three different colors across the nacelle 16 in a horizontal plane. Similarly, as shown in FIG. 11, the first UAV 44 flies upstream of the rotor 20, lifts the tracer generator 45 to a predetermined location, and then releases four different tracer materials 42 having four different colors across the nacelle 16 in a vertical plane.

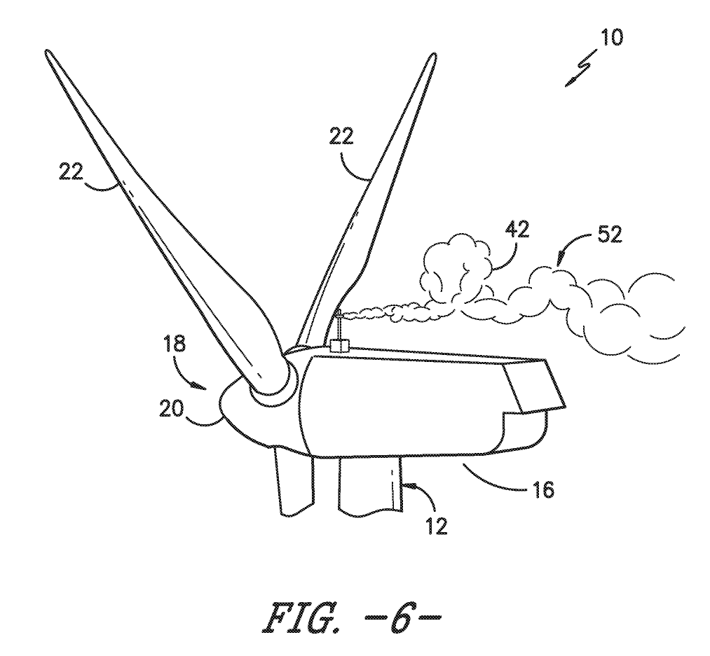

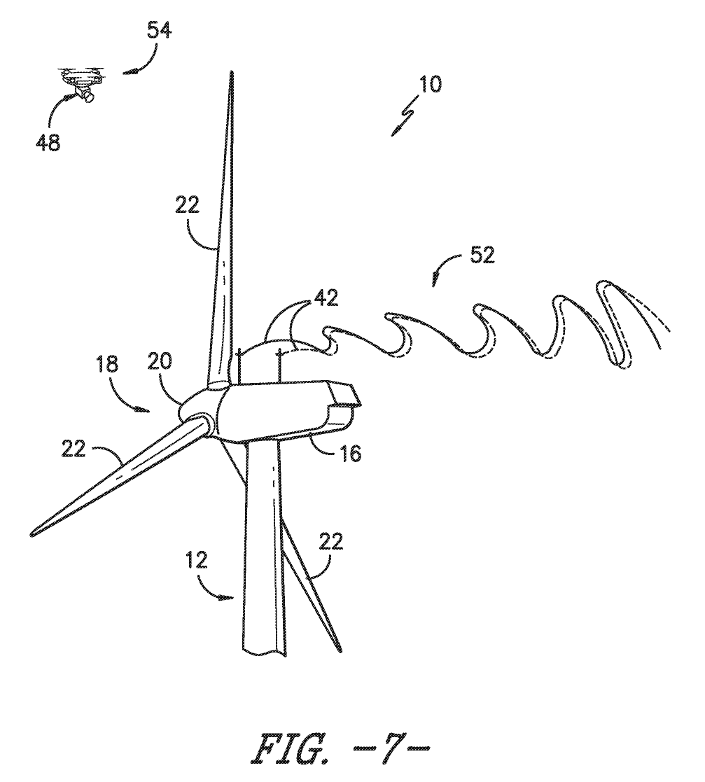

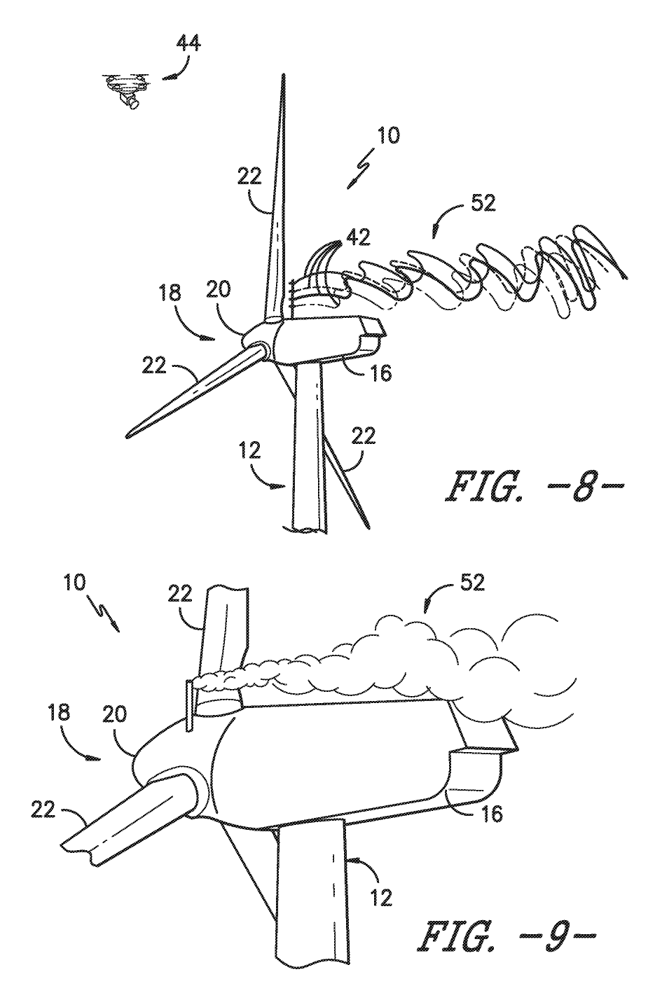

In further embodiments, as shown in FIG. 6, a single tracer material 42 of a single color released in a vertical line. Further, as shown, the tracer material 42 of FIG. 6 is released from a predetermined location atop the nacelle 16. In another embodiment, as shown in FIG. 7, two tracer materials 42 of two different colors are released in separate vertical lines. Like the embodiment of FIG. 6, the tracer materials 42 of FIG. 7 are also released from predetermined locations atop the top of the nacelle 16. In still another embodiment, as shown in FIG. 8, four tracer materials 42 of four different colors are released in separate vertical lines. Like the embodiment of FIGS. 6 and 7, the tracer materials 42 of FIG. 8 are also released from predetermined locations atop the top of the nacelle 16, e.g. using the tracer generator 45 illustrated in FIG. 5.

It should be understood that the tracer generator 45 can be designed to accommodate any number of tracer materials 42 having any suitable colors and can be arranged in a vertical line, a horizontal line, or grid pattern for increased contrast and data collection. For example, as shown in FIG. 5, a plurality of tracer generators 45 may be mounted to a stabilizing device 56 via one or more structural components 51 providing the desired arrangement of the tracer generators 45. As such, any number of tracer generators 45 may be provided on the stabilizing device 56 in any suitable pattern. Thus, in such embodiments, the first UAV 44 is configured to carry the device 56 for stabilizing the tracer release point, which could use passive or active aerodynamic controls to accomplish this mission. More specifically, as shown, the stabilizing device 56 may be mounted near the tracer generation, since this is the point that should be the most stable. As such, the stabilization device 56 may be located at the end of the tether 47 between the UAV 44 and the tracer release point. In such embodiments, the stabilizing device 56 may include parachutes, vertical stabilizers, horizontal stabilizers, kite tails, vertical wind screens, horizontal wind screens, gyroscopes, air to ground tethers, and/or any other suitable devices for stabilizing the predetermined location (i.e. the release point of the tracer material(s) 42).

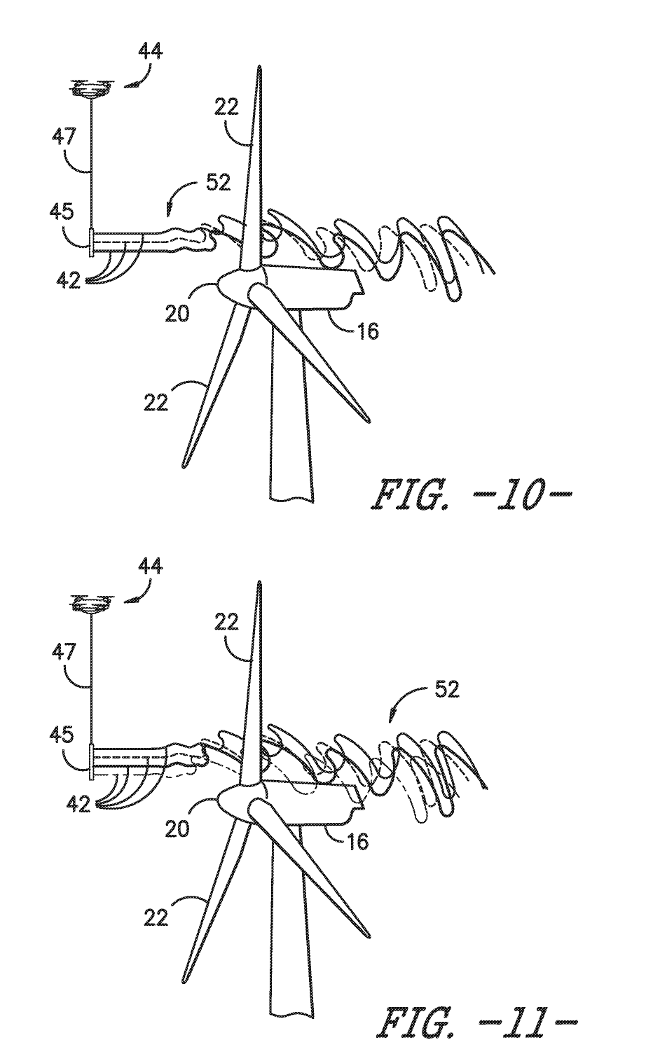

In yet another embodiment, the tracer generator 45 may be secured to one or more of the rotor blades 22 or the rotor 20 while the turbine is either stationary or in motion. For example, as shown in FIG. 9, the tracer generator 45 may be secured to the rotor 20 when the rotor 20 is parked. In such embodiments, the tracer material 42 may be released at a height corresponding to the maximum chord of the rotor blade 22.

Referring back to FIGS. 3 and 4, the system 40 also includes at least one sensor 46, 48, 50, 55 for monitoring a resultant flow pattern 52 of the tracer material(s) 42. Such sensors, for example, may include camera sensors, digital sensors, or any other sensor capable of generating still images, moving images, images outside the visible spectrum, etc. For example, as mentioned, the first UAV 44 may include a first camera sensor 46 for monitoring the resultant flow pattern 52 of the tracer material 42 from a first uptower location. In additional embodiments, as shown, the system 40 may also include a second UAV 54 at a second uptower location that is upstream from the first UAV 44 in position at the desired altitude and lateral position for the tracer release. In such embodiments, the second UAV 54 may include a second camera sensor 48 mounted thereto for monitoring the resultant flow pattern 52 of the tracer material 42 from a different, second uptower location. Accordingly, using the view from the second UAV 54 pointed downwind toward the wind turbine 10, the primary pilot on the first drone 44 can adjust the vertical and/or lateral positioning of the suspended tracer material 42 to target an area of interest in the wind turbine 10 or a wind farm.

Referring back to FIG. 4, the system 40 may further include an additional UAV 58 separate from the first and second UAVs 44, 54, such as a third (or fourth, fifth, etc.) drone, with one or more sensors mounted thereto (such as third camera sensor 55 for further monitoring the resultant flow pattern 52). Such UAVs 58 are configured to fly to any useful vantage point (e.g. at the same altitude as the second drone 54 but looking 90 degrees to it, horizontally across the flow of the tracer materials 42 toward the horizon, or positioned above or below the tracer release point looking vertically through the tracer material 42 toward the sky or the ground below).

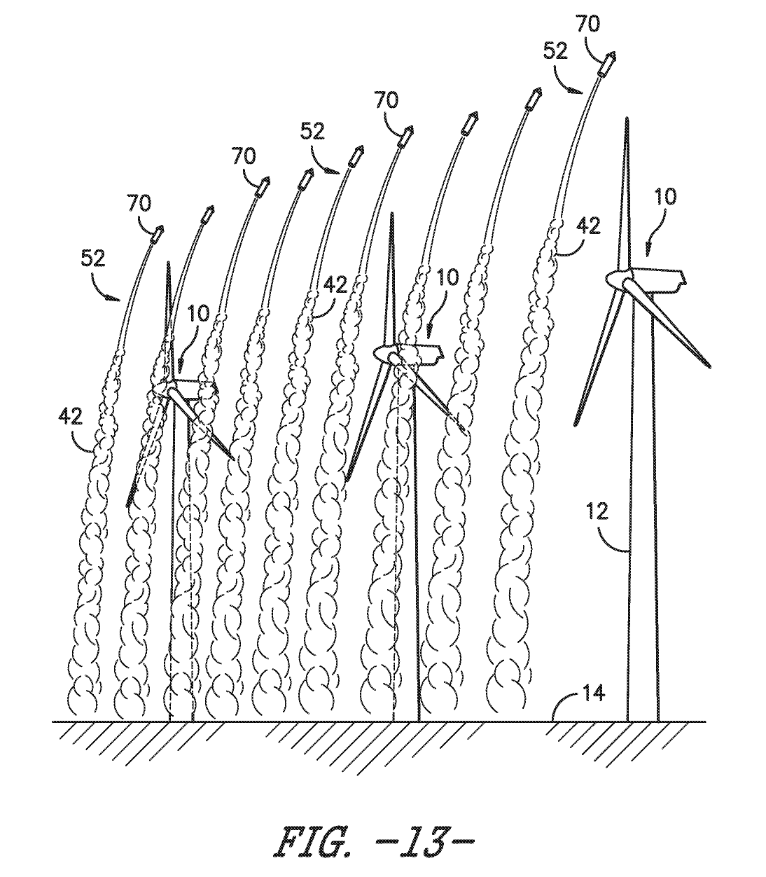

Multiple additional cameras 55 may also be positioned on the wind turbine 10 and/or its various components (i.e. the nacelle 16, the rotor blades 22, the rotor 18, and/or the tower 12 as well as on other solid mounting points such as the ground, met mast, crane, aircraft, vehicle, or kite) for further monitoring the resultant flow pattern 52. For example, as shown in FIG. 3, the additional sensor 55 is mounted to the nacelle 16 of the wind turbine 10. In addition, as shown in FIG. 12, an additional sensor 55 may be located on the ground near the wind turbine 10 to monitor the resultant flow pattern from a different vantage point.

In addition, as shown in FIGS. 4 and 5, the system 40 may also include a controller 60 communicatively coupled to the sensor(s) 46, 48, 50, 55. As such, the controller 60 is configured to receive data relating to the monitored resultant flow pattern 52 and implement a control action based on the resulting flow pattern 52, if needed. In exemplary embodiments, the met mast and wind turbine data collection systems may be synchronized with at least one of the sensors 46, 48, 50, 55.

FIGS. 3-12 generally illustrate the system 40 being released from a single wind turbine, however, it should be understood that the system 40 may be employed in a wind farm having a plurality of wind turbines 10 as well. For example, as shown in FIG. 13, a wind farm having a plurality of wind turbines 10 is illustrated in which a plurality of rockets 70 disperse the tracer material 42 in a plurality of locations. In such embodiments, the tracer material 42 assists in visualizing flow through the entire wind farm (or a subset of wind turbines in the wind farm). Thus, the flow of the tracer material 42 assists in providing a better understanding of wake effects for the wind farm and effects of surrounding terrain thereof. In addition, the tracer material 42 may be useful to visualize flow across the wind farm before the wind turbines 10 are installed to assist with siting.

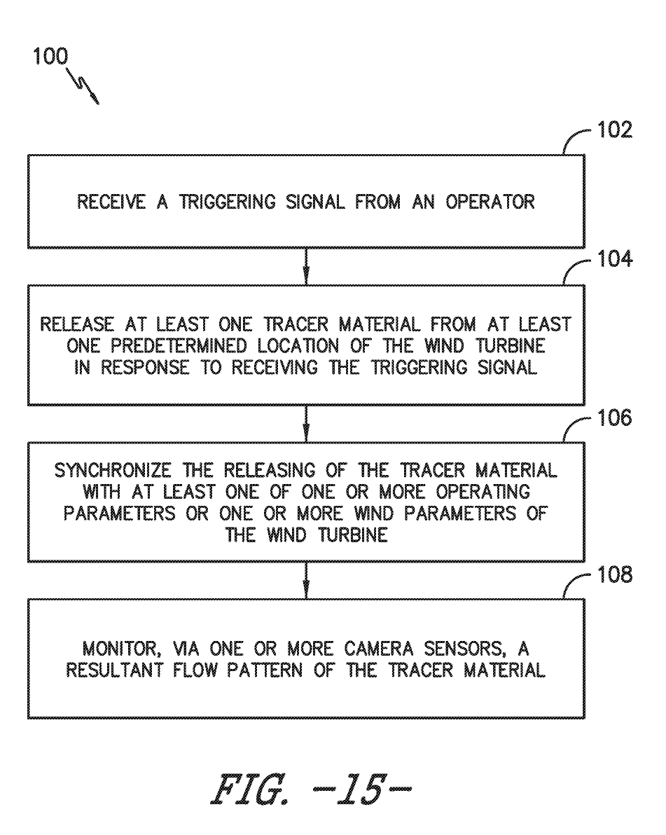

Referring now to FIG. 14, there is illustrated a block diagram of one embodiment of suitable components that may be included within the controller 60 (or the turbine controller 26) according to the present disclosure. As shown, the controller 60 may include one or more processor(s) 62 and associated memory device(s) 64 configured to perform a variety of computer-implemented functions (e.g., performing the methods, steps, calculations and the like and storing relevant data as disclosed herein). Additionally, the controller 60 may also include a communications module 66 to facilitate communications between the controller 60 and the various components of the wind turbine 10. Further, the communications module 66 may include a sensor interface 68 (e.g., one or more analog-to-digital converters) to permit signals transmitted from the sensors 46, 48, 50, 55 to be converted into signals that can be understood and processed by the processors 62. It should be appreciated that the sensors 46, 48, 50, 55 may be communicatively coupled to the communications module 66 using any suitable means. For example, as shown, the sensors 46, 48, 50, 55 are coupled to the sensor interface 68 via a wired connection. However, in other embodiments, the sensors 46, 48, 50, 55 may be coupled to the sensor interface 68 via a wireless connection, such as by using any suitable wireless communications protocol known in the art.

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 64 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 64 may generally be configured to store suitable computer-readable instructions that, when implemented by the processor(s) 62, configure the controller 60 to perform various functions including, but not limited to, transmitting suitable control signals to implement control action(s) in response to the resultant flow pattern 52 as described herein, as well as various other suitable computer-implemented functions.

Referring now to FIG. 15, a flow diagram of one embodiment of a method 100 for providing visual identification of a flow field of the wind turbine 10 is illustrated. As shown at 102, the method 100 includes receiving, e.g. via the first UAV 44, a triggering signal from an operator. In such embodiments, for example, the first drone 44 may be equipped with an antenna or receiver that can receive a triggering signal for remotely triggering the aviation smoke (or other tracer material) by an operator. Such triggering signals may use radio frequency signals, Wi-Fi signals, Bluetooth signals, or any other protocol for communication.

Thus, as shown at 104, the method 100 also includes releasing at least one tracer material 42 from at least one predetermined location near the wind turbine 10 in response to receiving the triggering signal. More specifically, as mentioned, the tracer material(s) 42 may be released from one of the aircrafts 44, 54, 58, a downtower location of the wind turbine 10, and/or an uptower location on the wind turbine 10. In certain embodiments, the uptower location(s) may include an upstream position relative to the rotor 20, a downstream position relative to the rotor 20, above the nacelle 16, below the nacelle 16, from a side of the nacelle 16, below the predetermined location, or another other suitable location. In addition, in one embodiment, the method 100 may include releasing the tracer material(s) 42 from the tracer generator 45 secured to the tether 47 extending downward from the first UAV 44.

As shown at 106, the method 100 may also include synchronizing the releasing of the tracer material(s) 42 with at least one of one or more operating parameters or one or more wind parameters of the wind turbine 10. For example, in certain embodiments, the operating parameter(s) may include a turbine speed, a yaw angle, a pitch angle, a power output, a torque output, or similar. Further, the wind parameter(s) may include wind speed, wind turbulence, wind gust, wind shear, or similar.

As shown at 108, the method 100 includes monitoring, via one or more sensors 46, 48, 50, 55, a resultant flow pattern 52 of the tracer material(s) 42. As such, the method 100 of the present disclosure enables the visualization of the flow field in proximity to a utility-scale wind turbine or wind turbine model using multiple semi-autonomous UAVs.

In certain embodiments, the step of monitoring the resultant flow pattern 52 of the tracer material(s) 42 may include providing the second UAV 54 at an upstream location from the first UAV 44 and monitoring, via the sensor 48 mounted to the second UAV 54, the resultant flow pattern 52 of the tracer material(s) 42. In yet another embodiment, the step of monitoring the resultant flow pattern 52 of the tracer material 42 may further include monitoring, via the additional UAV 58 or the additional sensors 50, 55 mounted to or near the wind turbine 10, the resultant flow pattern 52 of the tracer material 42.

In particular embodiments, as shown in FIG. 3, the method 100 may include directing the second sensor 48 mounted to the second UAV 54 downward toward the nacelle 16 of the wind turbine 10 and adjusting, via the first UAV 44, at least one of a vertical position or a lateral position of the tracer material 42 to target a desired area near the wind turbine 10.

In still further embodiments, the flow field of the wind turbine 10 may be observed using additional types of visualization. For example, lightweight streamers or ribbons can be deployed using all the methods described above. In addition, the visibility of the tracer material(s) 42 can be augmented with lasers or other focused light sources mounted to any portion of the wind turbine 10, UAVs, cranes, the met mast, and/or on the ground. The flow field may also be visualized using infrared cameras or film.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for providing visual identification of a flow field across one or more wind turbines, the method comprising:
releasing at least one tracer material from at least one predetermined location near the one or more wind turbines;
synchronizing the releasing of the tracer material with at least one of one or more operating parameters or one or more wind parameters of the one or more wind turbines; and,
monitoring, via one or more sensors, a resultant flow pattern of the tracer material.

2. The method of claim 1, further comprising releasing the at least one tracer material in at least one of a continuous stream or one or more bursts.

3. The method of claim 1, wherein releasing the at least one tracer material further comprises releasing a plurality of tracer materials having a plurality of different colors.

4. The method of claim 1, wherein releasing the at least one tracer material further comprises releasing the at least one tracer material in at least one of a vertical line, a horizontal line, a grid pattern, or combinations thereof

5. The method of claim 1, wherein releasing the at least one tracer material from the at least one predetermined location further comprises releasing the at least one tracer material from at least one of a first unmanned aerial vehicle (UAV), an uptower location of one or more of the wind turbines, a downtower location, or one or more aircrafts.

6. The method of claim 5, further comprising releasing the at least one tracer material from a tracer generator secured to a tether extending downward from the first UAV.

7. The method of claim 5, further comprising receiving a remote triggering signal from an operator and releasing the tracer material in response to receiving the triggering signal.

8. The method of claim 5, wherein monitoring, via the one or more sensors, the resultant flow pattern of the tracer material further comprises:
providing a second UAV at a different location from the first UAV; and,
monitoring, via at least one second sensor mounted to the second UAV, the resultant flow pattern of the tracer material.

9. The method of claim 8, further comprising:
directing the at least one second sensor mounted to the second UAV downward toward a nacelle of one of the one or more wind turbines;
adjusting, via the first UAV, at least one of a vertical position or a lateral position of the tracer material to target a desired area near the one or more wind turbines.

10. The method of claim 9, wherein monitoring, via the one or more sensors, the resultant flow pattern of the tracer material further comprises monitoring, via at least one of an additional UAV separate from the first and second UAVs or an additional sensor mounted to or near one of the one or more the wind turbines, the resultant flow pattern of the tracer material.

11. The method of claim 1, further comprising monitoring the resultant flow pattern of the tracer material from at least one of one or more uptower locations or one or more ground locations, the one or more uptower locations comprising at least one of an upstream position relative to a rotor of one of the one or more wind turbines, a downstream position relative to the rotor, above a nacelle of one of the one or more wind turbines, below the nacelle, from a side of the nacelle, or below the predetermined location.

12. The method of claim 11, wherein the one or more operating parameters comprises at least one of a rotational speed, a yaw angle, a pitch angle, a power output, or a torque output, and wherein the one or more wind parameters comprise at least one of wind speed, wind turbulence, wind gust, wind direction, or wind shear.

13. The method of claim 1, wherein the tracer material comprises at least one of solid particulates, liquid particulates, or combinations thereof

14. A system for providing visual identification of a flow field across one or more wind turbines, the system comprising:
at least one tracer material;
a first aircraft adapted to release the at least one tracer material from at least one predetermined location near the one or more wind turbines;
one or more sensors for monitoring a resultant flow pattern of the tracer material; and,
a controller communicatively coupled to the one or more sensors, the controller configured for receiving data relating to the monitored resultant flow pattern and implementing a control action based on the resulting flow pattern.

15. The system of claim 14, wherein the first aircraft comprises at least one of an unmanned aerial vehicle (UAV), an airplane, a helicopter, a kite, a tethered balloon, or a rocket.

16. The system of claim 14, further comprising a tracer generator secured to a tether extending downward from the first aircraft, the tracer generator configured for releasing the at least one tracer material.

17. The system of claim 14, wherein the first aircraft further comprises a stabilizing device for stabilizing the predetermined location.

18. The system of claim 17, wherein the stabilizing device comprises at least one of a parachute, a vertical stabilizer, a horizontal stabilizer, a kite tail, a wind screen, a mechanical tether connected to the ground, or gyroscopic mechanism.

19. The system of claim 14, further comprising a second aircraft adapted with one of the one or more sensors for further monitoring the resultant flow pattern of the tracer material.

20. The system of claim 19, further comprising at least one of an additional aircraft separate from the first and second aircrafts or an additional sensor mounted to or near the wind turbine for further monitoring the resultant flow pattern.
